(19) United States
(12) Patent Application Publication
(10) Pub. No.: US 2020/0272812 A1
(43) Pub. Date: Aug. 27, 2020

(54) HUMAN BODY PART SEGMENTATION WITH REAL AND SYNTHETIC IMAGES

(71) Applicant: Microsoft Technology Licensing, LLC, Redmond, WA (US)

(72) Inventors: Lijuan Wang, Redmond, WA (US); Zicheng Liu, Bellevue, WA (US); Kevin Lin, Redmond, WA (US); Kun Luo, Redmond, WA (US)

(21) Appl. No.: 16/281,876

(22) Filed: Feb. 21, 2019

(51) Int. Cl. G06K 9/00; G06K 9/62

(52) U.S. Cl. CPC G06K 9/00375; G06K 9/6256

(57) ABSTRACT

A machine accesses a training data set comprising multiple real images and multiple synthetic images. The machine trains a joint prediction module to predict joint locations in visual data using the multiple real images. The machine trains a part affinity field prediction module to identify adjacent joints in visual data using the multiple real images. The machine trains the joint prediction module to predict joint locations in visual data using the multiple synthetic images. The machine trains the part affinity field prediction module to identify adjacent joints in visual data using the multiple synthetic images. The machine trains a body part prediction module to identify body parts in visual data using the multiple synthetic images. The machine provides a trained human body part segmentation module comprising the trained joint prediction module, the trained part affinity field prediction module, and the trained body part prediction module.

### TECHNICAL FIELD

Some embodiments relate to artificial intelligence and machine learning. Some embodiments related to automating human body part segmentation in image(s).

### BACKGROUND

Human body part segmentation aims at partitioning persons in an image to multiple semantically consistent regions representing body parts (e.g., head, arms, legs, etc.). While manual human body part segmentation by a human user is generally easy, automating human body part segmentation may be challenging.

### BRIEF DESCRIPTION OF THE DRAWINGS

Some embodiments of the technology are illustrated, by way of example and not limitation, in the figures of the accompanying drawings.

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a data flow diagram for an inference phase, in accordance with some embodiments.

FIG. 7 is an overview data flow diagram for a training phase, in accordance with some embodiments.

FIG. 8 is a data flow diagram for a training with real data phase, in accordance with some embodiments.

FIG. 9 is a data flow diagram for a training with synthetic data phase, in accordance with some embodiments.

FIG. 10 illustrates an example of training data being provided to a human body part segmentation module, in accordance with some embodiments.

FIG. 11 illustrates a flow chart for an example method for training a human body part segmentation module, in accordance with some embodiments.

### SUMMARY

The present disclosure generally relates to machines configured to provide human body part segmentation with images, including computerized variants of such special-purpose machines and improvements to such variants, and to the technologies by which such special-purpose machines become improved compared to other special-purpose machines that provide technology for neural networks. In particular, the present disclosure addresses systems and methods for human body part segmentation with real and synthetic images.

According to some aspects of the technology described herein, a system includes processing circuitry and a memory storing instructions which, when executed by the processing circuitry, cause the processing circuitry to perform operations. The operations include accessing a training data set comprising a plurality of real images and a plurality of synthetic images. The operations include training a joint prediction module to predict joint locations in visual data using the plurality of real images. The operations include training a part affinity field prediction module to identify adjacent joints in visual data using the plurality of real images. The operations include training the joint prediction module to predict joint locations in visual data using the plurality of synthetic images. The operations include training the part affinity field prediction module to identify adjacent joints in visual data using the plurality of synthetic images. The operations include training a body part prediction module to identify body parts in visual data using the plurality of synthetic images. The operations include providing, as a digital transmission, a trained human body part segmentation module comprising the trained joint prediction module, the trained part affinity field prediction module, and the trained body part prediction module.

According to some aspects of the technology described herein, a machine-readable medium stores instructions which, when executed by one or more computing machines, cause the one or more computing machines to perform operations. The operations include accessing a training data set comprising a plurality of real images and a plurality of synthetic images. The operations include training a joint prediction module to predict joint locations in visual data using the plurality of real images. The operations include training a part affinity field prediction module to identify adjacent joints in visual data using the plurality of real images. The operations include training the joint prediction module to predict joint locations in visual data using the plurality of synthetic images. The operations include training the part affinity field prediction module to identify adjacent joints in visual data using the plurality of synthetic images. The operations include training a body part prediction module to identify body parts in visual data using the plurality of synthetic images. The operations include providing, as a digital transmission, a trained human body part segmentation module comprising the trained joint prediction module, the trained part affinity field prediction module, and the trained body part prediction module.

According to some aspects of the technology described herein, a method includes accessing a training data set comprising a plurality of real images and a plurality of synthetic images. The method includes training a joint prediction module to predict joint locations in visual data using the plurality of real images. The method includes training a part affinity field prediction module to identify adjacent joints in visual data using the plurality of real images. The method includes training the joint prediction module to predict joint locations in visual data using the plurality of synthetic images. The method includes training the part affinity field prediction module to identify adjacent joints in visual data using the plurality of synthetic images. The method includes training a body part prediction module to identify body parts in visual data using the plurality of synthetic images. The method includes providing, as a digital transmission, a trained human body part segmentation module comprising the trained joint prediction module, the trained part affinity field prediction module, and the trained body part prediction module.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As set forth above, human body part segmentation aims at partitioning persons in an image to multiple semantically consistent regions representing body parts (e.g., head, arms, legs, etc.). Manual human body part segmentation by a human user is usually easy, as a typical person can oftentimes understand where a human head, arm, leg, etc. are shown in a typical image. However, automating human body part segmentation may be challenging. Some aspects of the technology described herein are directed to using machine learning techniques to train a computing machine to perform human body part segmentation.

In accordance with some embodiments, a machine is trained to perform human body part segmentation using both real images (e.g., images showing real-life scenes taken by a camera) and synthetic images (e.g., computer-generated images). In some cases, the synthetic images identify ground truth body parts. (For example, a synthetic image may include labels showing where the head, torso, upper arm(s), lower arm(s), upper leg(s), and lower leg(s) are positioned.) However, in some cases, the real images do not identify ground truth body parts. (As adding such labels requires a large number of person-hours and, therefore, is expensive.)

In some aspects, a computing machine trains a human body part segmentation module to perform human body part segmentation. The human body part segmentation module includes a joint prediction module, a part affinity field prediction module, and a body part prediction module.

In some aspects, the computing machine accesses a training data set comprising a plurality of real images and a plurality of synthetic images. The computing machine trains a joint prediction module to predict joint locations in visual data using the plurality of real images. The computing machine trains a part affinity field prediction module to identify the association between adjacent joints in visual data using the plurality of real images. The computing machine trains the joint prediction module to predict joint locations in visual data using the plurality of synthetic images. The computing machine trains the part affinity field prediction module to identify the association between adjacent joints in visual data using the plurality of synthetic images. The computing machine trains a body part prediction module to identify body parts in visual data using the plurality of synthetic images. The computing machine provides, as a digital transmission, the trained human body part segmentation module comprising the trained joint prediction module, the trained part affinity field prediction module, and the trained body part prediction module.

While some embodiments are described herein referring to human bodies, it should be noted that the technology described herein may be used to segment other things, such as animal body parts or other structures (e.g., cars into car parts, airplanes into airplane parts, robots into robot parts, etc.). The technology is not limited to human body part segmentation.

As used herein, the phrase “computing machine” encompasses its plain and ordinary meaning. A “computing machine” may include one or more computing machines. A computing machine may include one or more of a server, a data repository, a client device, and the like. A client device may include a laptop computer, a desktop computer, a mobile phone, a smart watch, a tablet computer, a smart television, a personal digital assistant, a digital music player, and the like. A computing machine may be any device or set of devices that, alone or in combination, includes processing circuitry and memory.

### DESCRIPTION OF FIGURES

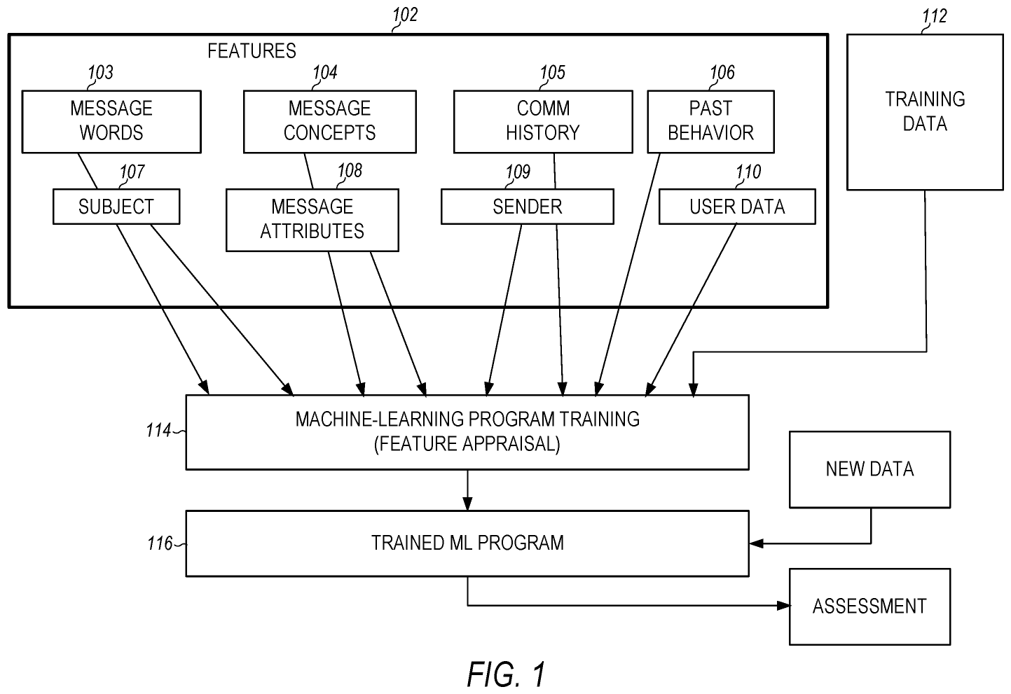

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that is has not been trained on. In a second example, a false positive rate or false negative rate may be used to evaluate the models after finalization. In a third example, a delineation between data clusterings is used to select a model that produces the clearest bounds for its clusters of data.

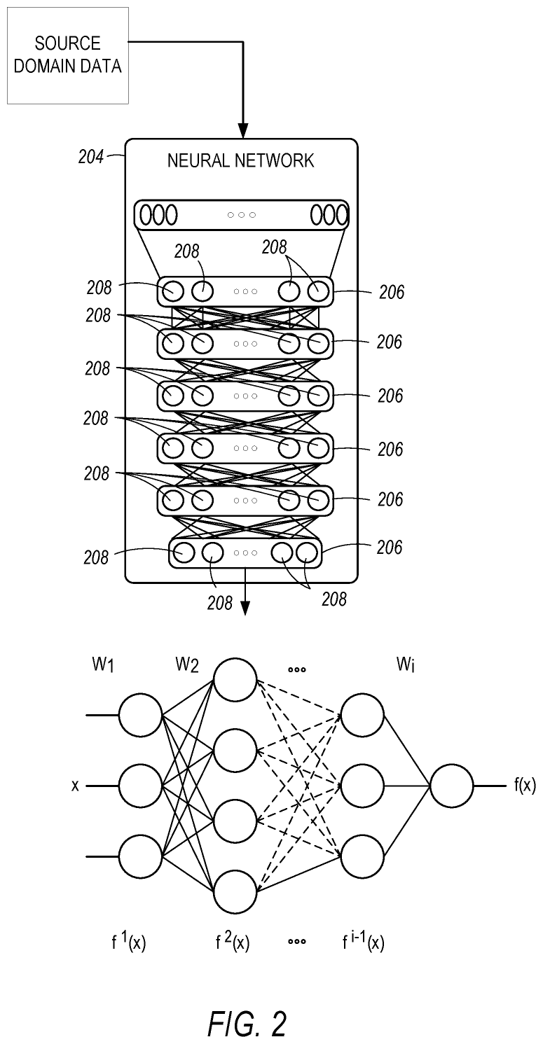

FIG. 2 illustrates an example neural network 204, in accordance with some embodiments. As shown, the neural network 204 receives, as input, source domain data 202. The input is passed through a plurality of layers 206 to arrive at an output. Each layer includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at f¹(x), f²(x), . . . , fⁱ⁻¹(x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

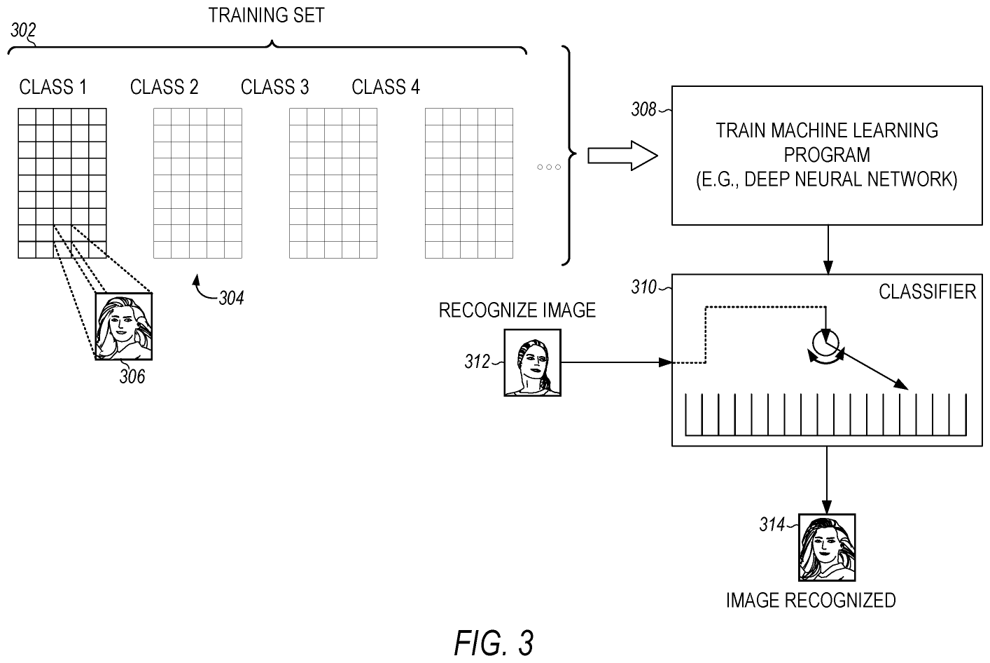

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Donald Trump, one class corresponds to Barack Obama, one class corresponds to George W. Bush, etc.). At block 308 the machine learning program is trained, for example, using a deep neural network. At block 310, the trained classifier, generated by the training of block 308, recognizes an image 312, and at block 314 the image is recognized. For example, if the image 312 is a photograph of Bill Clinton, the classifier recognizes the image as corresponding to Bill Clinton at block 314.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 314) corresponding to the input image 312.

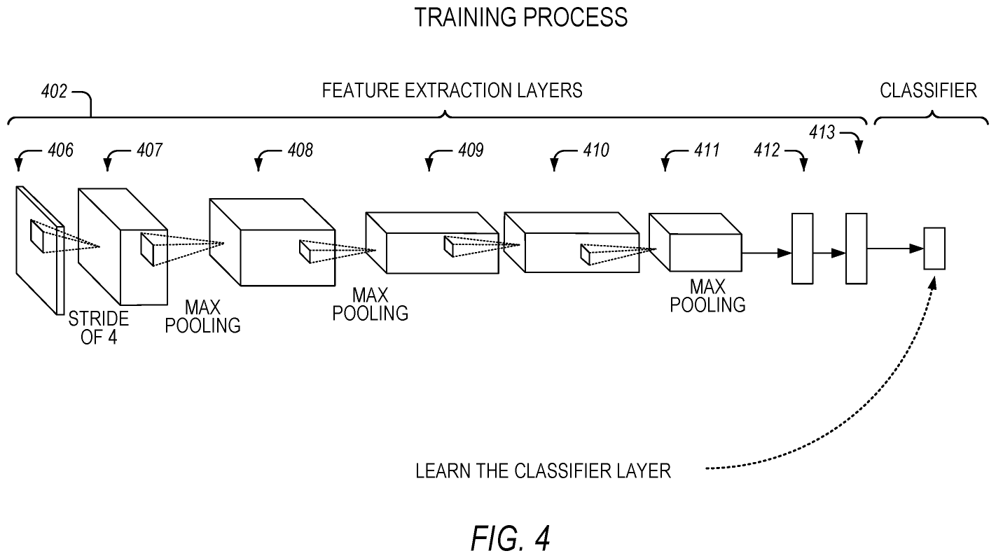

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as be reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

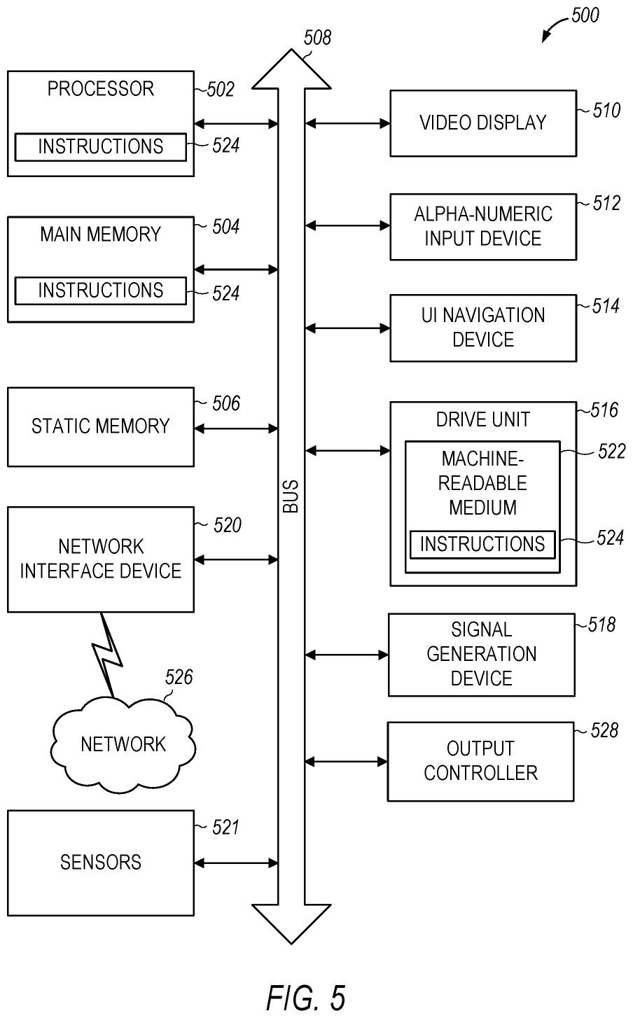

FIG. 5 illustrates a block diagram of a computing machine 500 in accordance with some embodiments. In some embodiments, the computing machine 500 may store the components shown in the circuit block diagram of FIG. 5. For example, the circuitry 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Human body part segmentation aims at partitioning persons in the image to multiple semantically consistent regions (e.g., head, arms, legs). This may be useful in various human behavior analysis applications. Supervised training with deep Convolutional Neural Networks (CNNs) significantly improves the performance of various visual recognition tasks. However, it requires a large amount of training data. Data labeling, especially at the pixel level, is labor intensive and the acquisition of such annotations in large sale might, in some cases, be prohibitively expensive.

One possible solution to address this problem is to take advantage of the graphics simulator to generate ground truths automatically. However, the discrepancies between the real and the synthetic data, sometimes called the reality gap, make it challenging to transfer knowledge from simulation data to real data. It should be noted that real data and synthetic data are actually complementary. For synthetic data, it might be easy to generate precise labels but it is difficult to synthesize images that match real image statistics. On the other hand, real data might, in some cases, come with rich coverage of variations, but might be expensive to collect ground truth labels especially at the pixel level. How to learn the rich knowledge from the real image statistics with the help of synthetic data labels is a problem addressed by some aspects disclosed herein.

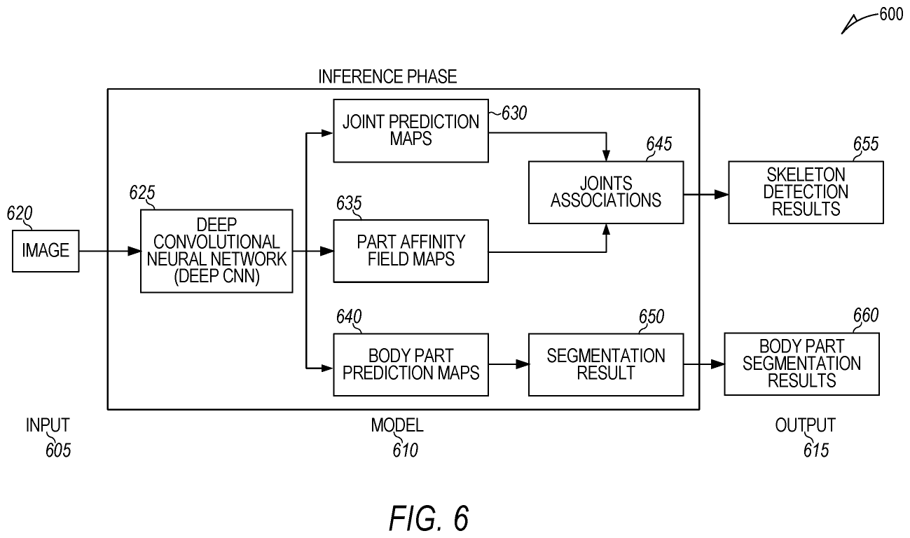

FIG. 6 is a data flow diagram for an inference phase 600 of human body part segmentation with real and synthetic images, in accordance with some embodiments. As shown in FIG. 6, an input 605 is provided to a model 610, which provides outputs 615. The input 605 includes an image 620. As illustrated, in the model 610, the image 620 is provided to a deep convolutional neural network (CNN) 625, which outputs joint prediction maps 630, part affinity field maps 635, and body part prediction maps 640. The joint prediction maps 630 include predicted joint locations. In some cases, the joint prediction maps 630 include a heat map for some or all of the joints of the skeleton. The joint prediction maps may include predictions for positions of only major joints (e.g., neck, knees, elbows, hips, and shoulders) or all of the joints of the human skeleton. The part affinity field maps 635 identify the connection between adjacent joints in the image 605. The part affinity field maps 635 may be represented as directional vectors. Adjacent joints include neighboring joints of the same person where there are no other joints between the neighboring joints. For example, the right shoulder of Person X is adjacent to the right elbow of Person X because Person X has no joints between the right shoulder and the right elbow. The body part prediction maps 640 identify body parts in the image 605 based on, in some cases, the joint prediction maps 630 and the part affinity field maps 635. For example, the right upper arm of Person X is likely between the right elbow of Person X and the right shoulder of Person X.

As shown, joint associations 645 are computed based on the joint prediction maps 630 and the part affinity field maps 635. Segmentation results 650 are computed based on the body part prediction maps 640. The output 615 include skeleton detection results 655 computed based on the joint associations 645 and body part segmentation results 660 computed from the segmentation results 650.

The joint associations 645 represent predictions of associations between neighboring joints, and predictions that neighboring joints belong to the same person (rather than two different people who are next to each other, e.g., dancing together or holding hands). In some cases, the joint associations 645 are computed using the Hungarian algorithm or any other combinatorial optimization algorithm.

The segmentation result 650 indicates, for each pixel, a probability representing how likely the pixel is to correspond to a given body part (e.g., a head, an upper right arm, etc.). The probabilities in the segmentation result 650 are used to generate the body part segmentation results 660, which indicate which pixel(s) correspond to which body part(s).

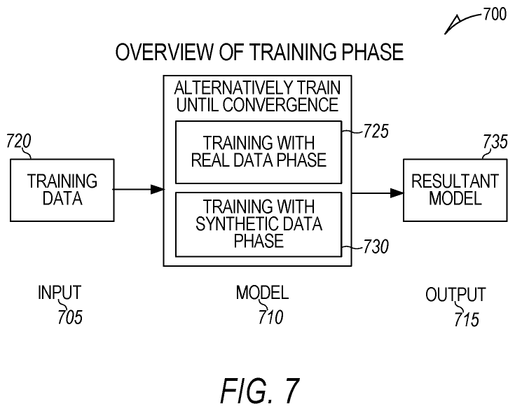

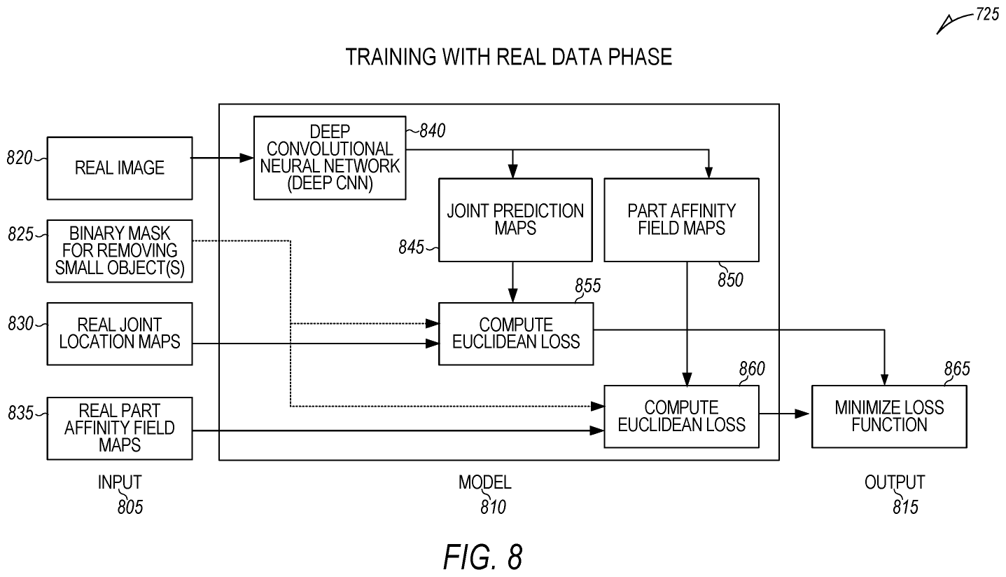

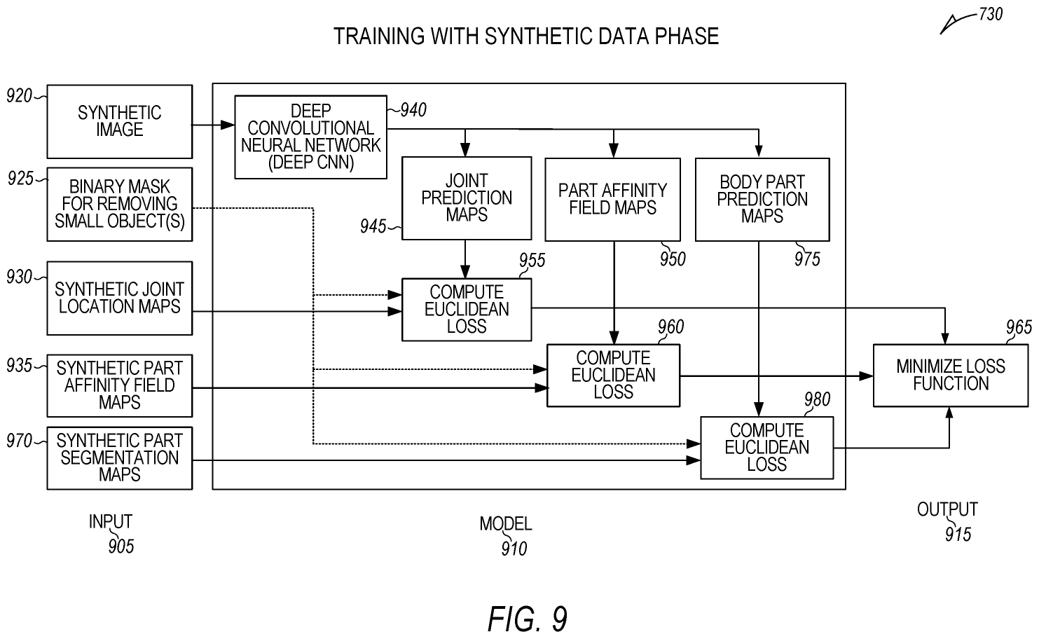

FIG. 7 is an overview data flow diagram for a training phase 700 of human body part segmentation with real and synthetic images, in accordance with some embodiments. As shown in FIG. 7, an input 705 is provided to a model training module 710, which provides output 715. The input 705 includes training data 720. The model training module 710 uses a training with real data phase 725 and a training with synthetic data phase 730 to alternatively train the model until convergence. The resultant model 735 is provided as the output 715. The training with real data phase 725 is described in detail in conjunction with FIG. 8. The training with synthetic data phase 730 is described in detail in conjunction with FIG. 9.

In some cases, the training data 720 includes both real images (e.g., images showing real-life scenes taken by a camera) and synthetic images (e.g., computer-generated images). In some cases, the synthetic images identify ground truth body parts. (For example, a synthetic image may include labels showing where the head, torso, upper arm(s), lower arm(s), upper leg(s), and lower leg(s) are positioned.) However, in some cases, the real images do not identify ground truth body parts. (As adding such labels requires a large number of person-hours and, therefore, is expensive.) The training with real data phase 725 trains the model using the real images. The training with synthetic data phase 735 trains the model using the synthetic images. The synthetic images are useful in training because they identify the ground truth body parts. The real images are useful in training because they are more diverse than the synthetic images and include people in a larger variety of poses, for example people in unusual poses doing complex athletic or dance movements. The athletic or dance movements may include bending a threshold number (e.g., two, three, four or five) of joints. The joints may be selected from a group comprising: knee joints, hip joints, shoulder joints, elbow joints, and neck joints.

FIG. 8 is a data flow diagram for the training with real data phase 725 of human body part segmentation with real and synthetic images, in accordance with some embodiments. As shown, the training with real data phase 725 includes input 805 being provide to a model 810, which generates output 815. The input 805 includes a real image 820, a binary mask 825 for removing small object(s) (e.g., small human(s) or human(s) taking up fewer than a threshold number of pixels), real joint location maps 830, and real part affinity field maps 835. The real image 820 may be represented as a set of pixels, with each pixel having a red-green-blue (RGB) color model value.

In the model 810, the real image 820 is provided to a deep CNN 840, which generates joint prediction maps 845 and part affinity field maps 850. A Euclidian (or other) loss function 855 is computed for the joint prediction maps 845 with respect to the real joint location maps 830 and the binary mask 825. A Euclidian (or other) loss function 860 is computed for the part affinity field maps 850 with respect to the real apart affinity field maps 835 and the binary mask 825. The results of the loss functions 855 and 860 are provided to the output 815 to minimize the combined loss function 865. FIG. 8 is described here in conjunction with a Euclidian loss function. However, other loss functions, such as cross entropy loss, may be used in addition to or in place of the Euclidian loss function. It should be noted that the real joint location maps 830 and the real part affinity maps 835 represent ground truth values.

FIG. 9 is a data flow diagram for the training with synthetic data phase 730 of human body part segmentation with real and synthetic images, in accordance with some embodiments. As shown, the training with synthetic data phase 735 includes input 905 being provide to a model 910, which generates output 915. The input 905, similarly to the input 805, includes a synthetic image 920, a binary mask 925 for removing small object(s), synthetic joint location maps 930 and synthetic part affinity field maps 935. In addition, the input 905 includes synthetic part segmentation maps 970.

In the model 910, similarly to the model 810, the synthetic image 920 is provided to a deep CNN 940, which generates joint prediction maps 945 and part affinity field maps 950. In addition, the deep CNN 940 generates body part prediction maps 975. A Euclidian (or other) loss function 955 is computed for the joint prediction maps 945 with respect to the synthetic joint location maps 930 and the binary mask 925. A Euclidian (or other) loss function 960 is computed for the part affinity field maps 950 with respect to the synthetic apart affinity field maps 935 and the binary mask 925. In addition, a Euclidian (or other) loss function 980 is computed for the body part prediction maps 975 with respect to the synthetic part segmentation maps 970 and the binary mask 925. The results of the loss functions 955, 960, and 980 are provided to the output 915 to minimize the combined loss function 965. FIG. 9 is described here in conjunction with a Euclidian loss function. However, other loss functions, such as cross entropy loss, may be used in addition to or in place of the Euclidian loss function. It should be noted that the synthetic joint location maps 930 and the synthetic part affinity maps 935 represent ground truth values.

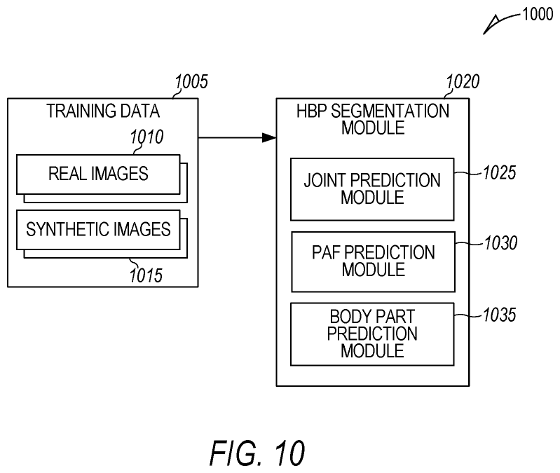

FIG. 10 illustrates an example 1000 of training data 1005 being provided to a human body part (HBP) segmentation module 1020, in accordance with some embodiments. The training data 1005 and the HBP segmentation module 1020 may be stored in the memory of one or more computing machines. As shown, the training data 1005 includes real images 1010 and synthetic images 1015 that are provided to the HBP segmentation module 1020.

In some cases, the synthetic images 1015 identify ground truth body parts. (For example, a synthetic image may include labels showing where the head, torso, upper arm(s), lower arm(s), upper leg(s), and lower leg(s) are positioned.) However, in some cases, the real images 1010 do not identify ground truth body parts. (As adding such labels requires a large number of person-hours and, therefore, is expensive.) The synthetic images 1015 are useful in training because they identify the ground truth body parts. The real images 1010 are useful in training because they are more diverse than the real images and include people in a larger variety of poses, for example people in unusual poses doing complex athletic or dance movements. The athletic or dance movements may include bending a threshold number (e.g., two, three, four or five) of joints. The joints may be selected from a group comprising: knee joints, hip joints, shoulder joints, elbow joints, and neck joints.

The HBP segmentation module 1020 uses the training data 1005 to train itself to provide human body part segmentation. As shown, the HBP segmentation module 1020 includes a joint prediction module 1025, a part affinity field (PAF) prediction module 1030, and a body part prediction module 1035. The HBP segmentation module 1020 is trained using the real images 1010 and the synthetic images 1015 in different training phases. The joint prediction module 1025 is trained using the real images 1010 and the synthetic images 1015 in different training phases. The body part prediction module 1035 is trained using the synthetic images 1015. However, in some cases, the body part prediction module 1035 is not trained using the real images 1010. In some embodiments, the real images 1010 might not be useful by the body part prediction module 1035 in supervised learning technology because different body part might not be labeled in the real images, as such labeling might be costly in terms of person-hours (or money to compensate employee(s) or contractor(s) for the person-hours).

In some cases, the synthetic images 1015 are useful in training because they identify ground truth body parts (whereas the real images 1010 might, in some cases, not identify the ground truth body parts). The identified ground truth body parts in the synthetic images 1015 may include one or more of: a head, a torso, an upper arm, a lower arm, an upper leg, and a lower leg. For example, one of the synthetic images 1015 may identify certain pixels as corresponding to the lower left leg of Person Y.

In some cases, the real images 1010 are useful in training because they are more diverse than the synthetic images and include people in a larger variety of poses, for example people (e.g., in unusual poses) performing athletic or dance movements. The athletic or dance movements may include bending at least a threshold number (e.g., two, three, four or five) of joints. The joints may be selected from a group comprising: knee joints, hip joints, shoulder joints, elbow joints, and neck joints.

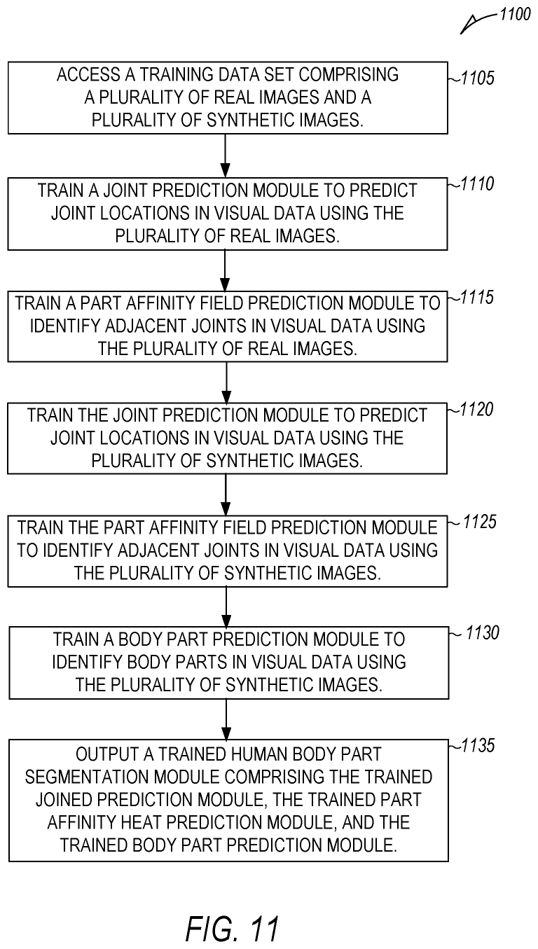

FIG. 11 illustrates a flow chart for an example method 1100 for training the human body part segmentation module 1020, in accordance with some embodiments. The method 1100 may be implemented by computing machine(s).

At operation 1105, the computing machine(s) access the training data set 1005 comprising a plurality of real images 1010 and a plurality of synthetic images 1015.

At operation 1110, the computing machine(s) train the joint prediction module 1025 to predict joint locations in visual data (e.g., one or more images, videos, or camera data received in real time) using the plurality of real images 1010.

At operation 1115, the computing machine(s) train the part affinity field prediction module 1030 to identify adjacent joints in visual data using the plurality of real images 1010.

In some cases, training the joint prediction module 1025 to predict joint locations in visual data using the plurality of real images comprises computing a first Euclidian loss between predicted joint locations in the plurality of real images and ground truth joint locations in the plurality of real images. Training the part affinity field prediction module 1030 to identify adjacent joints in visual data using the plurality of real images comprises computing a second Euclidian loss between predicted adjacent joints in the plurality of real images and ground truth adjacent joints in the plurality of real images. The computing machine(s) minimizing a real image loss function based on the first Euclidian loss and the second Euclidian loss.

At operation 1120, the computing machine(s) train the joint prediction module 1025 to predict joint locations in visual data using the plurality of synthetic images 1015.

At operation 1125, the computing machine(s) train the part affinity field prediction module 1030 to identify adjacent joints in visual data using the plurality of synthetic images 1015.

At operation 1130, the computing machine(s) train the body part prediction module 1035 to identify body parts in visual data using the plurality of synthetic images 1015.

In some cases, training the joint prediction module 1025 to predict joint locations in visual data using the plurality of synthetic images comprises computing a first Euclidian loss between predicted joint locations in the plurality of synthetic images and ground truth joint locations in the plurality of synthetic images. Training the part affinity field prediction module 1030 to identify adjacent joints in visual data using the plurality of synthetic images comprises computing a second Euclidian loss between predicted adjacent joints in the plurality of synthetic images and ground truth adjacent joints in the plurality of synthetic images. Training the body part prediction module 1035 to identify body parts in visual data using the plurality of synthetic images comprises computing a third cross entropy loss between predicted body parts in the plurality of synthetic images and ground truth body parts in the plurality of synthetic images. The computing machine(s) minimize a synthetic image loss function based on the first Euclidian loss and the second Euclidian loss and the third cross entropy loss. In some cases, the real image loss function and the synthetic image loss function are different functions. In some cases, a single function includes both the real image loss function and the synthetic image loss function.

The operations 1110-1030 may be repeated until the trained joint prediction module 1025, the trained part affinity field prediction module 1030, and the trained body part prediction module 1035 have loss function(s) that are below a threshold. After the loss function(s) are below the threshold, the training may be completed.

At operation 1135, after the training is completed, the computing machine(s) output (e.g., provide as a digital transmission) the trained human body part segmentation module 1020, which includes the trained joint prediction module 1025, the trained part affinity field prediction module 1030, and the trained body part prediction module 1035. After operation 1135, the method 1100 ends.

After the training is completed, the computing machine(s) may identify, using the trained human body part segmentation module 1020, one or more human body parts in a visual data item. The identification of the human body part(s) may be useful, for example, in identifying an activity in which the human is engaged, or in estimating a likelihood of success of an athletic maneuver or game play strategy. The human body part(s) may include one or more of: a head, a torso, a left upper arm, a right upper arm, a left lower arm, a right lower arm, a left hand, a right hand, a left foot, a right foot, a left upper leg, a right upper leg, a left lower leg, and a right lower leg.

As described above, the operations 1105-1135 of the method 1100 are performed according to a given order. However, it should be noted that the operations may be performed in any order, not necessarily the order given here. In some cases, some of the operations 1105-1135 may be skipped. In some cases, two or more of the operations 1105-1135 may be performed in parallel.

In summary, some aspects disclosed herein propose a deep learning framework to leverage the real and the synthetic data for the task of multi-person part segmentation. In some aspects, a computing machine has part segmentation labels from synthetic data, but does not have part segmentation labels from real data. One goal is to learn a part segmentation function that works well on real data. Some aspects are inspired by the human brain's complementary learning system where the fast learning component, called the hippocampus, encodes a crisp and episodic memory, while the neocortex component extracts a highly generalized “gist” representation that integrates over many different episodes. In some aspects, the learning from synthetic data with part segmentation labels behaves like the brain's fast learning system while the learning from the real data performs generalization.

Since the real data does not have part segmentation labels, some aspects use the skeleton label, which is common to both the synthetic and real data, and introduce an auxiliary task of pose estimation to bridge the two domains. Because skeleton labels are already available on large scale datasets like the COCO (Common Objects in Context) dataset developed by Microsoft Corporation of Redmond, Wash., and are less expensive to obtain than part segmentation labels, some aspects of the disclosed technique may, in some cases, save labeling efforts. As a result, some aspects learn human part segmentation from the part labels on the synthetic data, yet perform well on real images. In sum, some aspects introduce a learning framework, cross-domain complementary learning, to leverage the real and the synthetic data for multi-person part segmentation. Some aspects can be generalized to use with skeletons other than those of humans, such as non-human animal skeletons.

### NUMBERED EXAMPLES

Certain embodiments are described herein as numbered examples 1, 2, 3, etc. These numbered examples are provided as examples only and do not limit the subject technology.

Example 1 is a system comprising: processing circuitry; and a memory storing instructions which, when executed by the processing circuitry, cause the processing circuitry to perform operations comprising: accessing a training data set comprising a plurality of real images and a plurality of synthetic images; training a joint prediction module to predict joint locations in visual data using the plurality of real images; training a part affinity field prediction module to identify adjacent joints in visual data using the plurality of real images; training the joint prediction module to predict joint locations in visual data using the plurality of synthetic images; training the part affinity field prediction module to identify adjacent joints in visual data using the plurality of synthetic images; training a body part prediction module to identify body parts in visual data using the plurality of synthetic images; and providing, as a digital transmission, a trained human body part segmentation module comprising the trained joint prediction module, the trained part affinity field prediction module, and the trained body part prediction module.

In Example 2, the subject matter of Example 1 includes, the operations further comprising: identifying, using the trained human body part segmentation module, one or more human body parts in a visual data item.

In Example 3, the subject matter of Example 2 includes, wherein the one or more human body parts comprise one or more of: a head, a torso, an upper arm, a lower arm, an upper leg, and a lower leg.

In Example 4, the subject matter of Examples 1-3 includes, wherein: training the joint prediction module to predict joint locations in visual data using the plurality of real images comprises computing a first Euclidian loss between predicted joint locations in the plurality of real images and ground truth joint locations in the plurality of real images; and training the part affinity field prediction module to identify adjacent joints in visual data using the plurality of real images comprises computing a second Euclidian loss between predicted adjacent joints in the plurality of real images and ground truth adjacent joints in the plurality of real images; and wherein: the operations further comprise: minimizing a loss function based on the first Euclidian loss and the second Euclidian loss.

In Example 5, the subject matter of Examples 1-4 includes, wherein: training the joint prediction module to predict joint locations in visual data using the plurality of synthetic images comprises computing a first cross entropy loss between predicted joint locations in the plurality of synthetic images and ground truth joint locations in the plurality of synthetic images; training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and training the body part prediction module to identify body parts in visual data using the plurality of synthetic images comprises computing a third cross entropy loss between predicted body parts in the plurality of synthetic images and ground truth body parts in the plurality of synthetic images; and wherein: the operations further comprise: minimizing a loss function based on the first cross entropy loss, the second cross entropy loss, and the third cross entropy loss.

In Example 6, the subject matter of Example 5 includes, wherein the synthetic images identify ground truth body parts, and wherein the real images do not identify ground truth body parts.

In Example 7, the subject matter of Example 6 includes, wherein the identified ground truth body parts in the synthetic images comprise one or more of: a head, a torso, an upper arm, a lower arm, an upper leg, and a lower leg.

In Example 8, the subject matter of Examples 1-7 includes, wherein the plurality of real images comprise images of people performing athletic or dance movements, the athletic or dance movements comprising bending at least four joints.

In Example 9, the subject matter of Examples 1-8 includes, the at least four joints being selected from a group comprising: knee joints, hip joints, shoulder joints, elbow joints, and neck joints.

Example 10 is a method comprising: accessing a training data set comprising a plurality of real images and a plurality of synthetic images; training a joint prediction module to predict joint locations in visual data using the plurality of real images; training a part affinity field prediction module to identify adjacent joints in visual data using the plurality of real images; training the joint prediction module to predict joint locations in visual data using the plurality of synthetic images; training the part affinity field prediction module to identify adjacent joints in visual data using the plurality of synthetic images; training a body part prediction module to identify body parts in visual data using the plurality of synthetic images; and providing, as a digital transmission, a trained human body part segmentation module comprising the trained joint prediction module, the trained part affinity field prediction module, and the trained body part prediction module.

In Example 11, the subject matter of Example 10 includes, identifying, using the trained human body part segmentation module, one or more human body parts in a visual data item.

In Example 12, the subject matter of Example 11 includes, wherein the one or more human body parts comprise one or more of: a head, a torso, an upper arm, a lower arm, an upper leg, and a lower leg.

In Example 13, the subject matter of Examples 10-12 includes, wherein: training the joint prediction module to predict joint locations in visual data using the plurality of real images comprises computing a first Euclidian loss between predicted joint locations in the plurality of real images and ground truth joint locations in the plurality of real images; and training the part affinity field prediction module to identify adjacent joints in visual data using the plurality of real images comprises computing a second Euclidian loss between predicted adjacent joints in the plurality of real images and ground truth adjacent joints in the plurality of real images; and wherein: the method further comprises: minimizing a loss function based on the first Euclidian loss and the second Euclidian loss.

In Example 14, the subject matter of Examples 10-13 includes, wherein: training the joint prediction module to predict joint locations in visual data using the plurality of synthetic images comprises computing a first cross entropy loss between predicted joint locations in the plurality of synthetic images and ground truth joint locations in the plurality of synthetic images; training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and training the body part prediction module to identify body parts in visual data using the plurality of synthetic images comprises computing a third cross entropy loss between predicted body parts in the plurality of synthetic images and ground truth body parts in the plurality of synthetic images; and wherein: the method further comprises: minimizing a loss function based on the first cross entropy loss, the second cross entropy loss, and the third cross entropy loss.

In Example 15, the subject matter of Example 14 includes, wherein the synthetic images identify ground truth body parts, and wherein the real images do not identify ground truth body parts.

In Example 16, the subject matter of Example 15 includes, wherein the identified ground truth body parts in the synthetic images comprise one or more of: a head, a torso, an upper arm, a lower arm, an upper leg, and a lower leg.

Example 17 is a method comprising: receiving, at a computing device, a visual data item; identifying, using a human body part segmentation module, one or more human body parts in a visual data item; and providing, via the computing device, an output representing the identified one or more human body parts, wherein the human body part segmentation module comprises a trained joint prediction module, a trained part affinity field prediction module and trained body part prediction module; wherein, the joint prediction module is trained to predict joint locations in visual data using the plurality of real images; the part affinity field prediction module is trained to identify adjacent joints in visual data using the plurality of real images; the joint prediction module is trained to predict joint locations in visual data using the plurality of synthetic images; the part affinity field prediction module is trained to identify adjacent joints in visual data using the plurality of synthetic images; and the body part prediction module of the one or more computing machines is trained to identify body parts in visual data using the plurality of synthetic images.

In Example 18, the subject matter of Example 17 includes, wherein the one or more human body parts comprise one or more of: a head, a torso, an upper arm, a lower arm, an upper leg, and a lower leg.

In Example 19, the subject matter of Examples 17-18 includes, wherein: training the joint prediction module to predict joint locations in visual data using the plurality of real images comprises computing a first Euclidian loss between predicted joint locations in the plurality of real images and ground truth joint locations in the plurality of real images; and training the part affinity field prediction module to identify adjacent joints in visual data using the plurality of real images comprises computing a second Euclidian loss between predicted adjacent joints in the plurality of real images and ground truth adjacent joints in the plurality of real images; and wherein: a loss function based on the first Euclidian loss and the second Euclidian loss is minimized.

In Example 20, the subject matter of Examples 17-19 includes, wherein: training the joint prediction module to predict joint locations in visual data using the plurality of synthetic images comprises computing a first cross entropy loss between predicted joint locations in the plurality of synthetic images and ground truth joint locations in the plurality of synthetic images; training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and training the body part prediction module to identify body parts in visual data using the plurality of synthetic images comprises computing a third cross entropy loss between predicted body parts in the plurality of synthetic images and ground truth body parts in the plurality of synthetic images; and wherein: a loss function based on the first cross entropy loss, the second cross entropy loss, and the third cross entropy loss is minimized.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that an record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components might not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

What is claimed is:

1. A system comprising:
processing circuitry; and
a memory storing instructions which, when executed by the processing circuitry, cause the processing circuitry to perform operations comprising:
accessing a training data set comprising a plurality of real images and a plurality of synthetic images;
training a joint prediction module to predict joint locations in visual data using the plurality of real images;
training a part affinity field prediction module to identify adjacent joints in visual data using the plurality of real images;
training the joint prediction module to predict joint locations in visual data using the plurality of synthetic images;
training the part affinity field prediction module to identify adjacent joints in visual data using the plurality of synthetic images;
training a body part prediction module to identify body parts in visual data using the plurality of synthetic images; and
providing, as a digital transmission, a trained human body part segmentation module comprising the trained joint prediction module, the trained part affinity field prediction module, and the trained body part prediction module.

2. The system of claim 1, the operations further comprising:
identifying, using the trained human body part segmentation module, one or more human body parts in a visual data item.

3. The system of claim 2, wherein the one or more human body parts comprise one or more of: a head, a torso, an upper arm, a lower arm, an upper leg, and a lower leg.

4. The system of claim 1, wherein:
training the joint prediction module to predict joint locations in visual data using the plurality of real images comprises computing a first Euclidian loss between predicted joint locations in the plurality of real images and ground truth joint locations in the plurality of real images; and
training the part affinity field prediction module to identify adjacent joints in visual data using the plurality of real images comprises computing a second Euclidian loss between predicted adjacent joints in the plurality of real images and ground truth adjacent joints in the plurality of real images; and wherein:
the operations further comprise: minimizing a loss function based on the first Euclidian loss and the second Euclidian loss.

5. The system of claim 1, wherein:
training the joint prediction module to predict joint locations in visual data using the plurality of synthetic images comprises computing a first cross entropy loss between predicted joint locations in the plurality of synthetic images and ground truth joint locations in the plurality of synthetic images;
training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and
training the body part prediction module to identify body parts in visual data using the plurality of synthetic images comprises computing a third cross entropy loss between predicted body parts in the plurality of synthetic images and ground truth body parts in the plurality of synthetic images; and wherein:
the operations further comprise: minimizing a loss function based on the first cross entropy loss, the second cross entropy loss, and the third cross entropy loss.

6. The system of claim 5, wherein the synthetic images identify ground truth body parts, and wherein the real images do not identify ground truth body parts.

7. The system of claim 6, wherein the identified ground truth body parts in the synthetic images comprise one or more of: a head, a torso, an upper arm, a lower arm, an upper leg, and a lower leg.

8. The system of claim 1, wherein the plurality of real images comprise images of people performing athletic or dance movements, the athletic or dance movements comprising bending at least four joints.

9. The system of claim 1, the at least four joints being selected from a group comprising: knee joints, hip joints, shoulder joints, elbow joints, and neck joints.

10. A method comprising:
accessing a training data set comprising a plurality of real images and a plurality of synthetic images;
training a joint prediction module to predict joint locations in visual data using the plurality of real images;
training a part affinity field prediction module to identify adjacent joints in visual data using the plurality of real images;
training the joint prediction module to predict joint locations in visual data using the plurality of synthetic images;
training the part affinity field prediction module to identify adjacent joints in visual data using the plurality of synthetic images;
training a body part prediction module to identify body parts in visual data using the plurality of synthetic images; and
providing, as a digital transmission, a trained human body part segmentation module comprising the trained joint prediction module, the trained part affinity field prediction module, and the trained body part prediction module.

11. The method of claim 10, further comprising:
identifying, using the trained human body part segmentation module, one or more human body parts in a visual data item.

12. The method of claim 11, wherein the one or more human body parts comprise one or more of: a head, a torso, an upper arm, a lower arm, an upper leg, and a lower leg.

13. The method of claim 10, wherein:
training the joint prediction module to predict joint locations in visual data using the plurality of real images comprises computing a first Euclidian loss between predicted joint locations in the plurality of real images and ground truth joint locations in the plurality of real images; and
training the part affinity field prediction module to identify adjacent joints in visual data using the plurality of real images comprises computing a second Euclidian loss between predicted adjacent joints in the plurality of real images and ground truth adjacent joints in the plurality of real images; and wherein:
the method further comprises: minimizing a loss function based on the first Euclidian loss and the second Euclidian loss.

14. The method of claim 10, wherein:
training the joint prediction module to predict joint locations in visual data using the plurality of synthetic images comprises computing a first cross entropy loss between predicted joint locations in the plurality of synthetic images and ground truth joint locations in the plurality of synthetic images;
training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and
training the body part prediction module to identify body parts in visual data using the plurality of synthetic images comprises computing a third cross entropy loss between predicted body parts in the plurality of synthetic images and ground truth body parts in the plurality of synthetic images; and wherein:
the method further comprises: minimizing a loss function based on the first cross entropy loss, the second cross entropy loss, and the third cross entropy loss.

15. The method of claim 14, wherein the synthetic images identify ground truth body parts, and wherein the real images do not identify ground truth body parts.

16. The method of claim 15, wherein the identified ground truth body parts in the synthetic images comprise one or more of: a head, a torso, an upper arm, a lower arm, an upper leg, and a lower leg.

17. A method comprising:
receiving, at a computing device, a visual data item;
identifying, using a human body part segmentation module, one or more human body parts in a visual data item; and
providing, via the computing device, an output representing the identified one or more human body parts, wherein the human body part segmentation module comprises a trained joint prediction module, a trained part affinity field prediction module and trained body part prediction module;
wherein,
the joint prediction module is trained to predict joint locations in visual data using the plurality of real images;
the part affinity field prediction module is trained to identify adjacent joints in visual data using the plurality of real images;
the joint prediction module is trained to predict joint locations in visual data using the plurality of synthetic images;
the part affinity field prediction module is trained to identify adjacent joints in visual data using the plurality of synthetic images; and
the body part prediction module of the one or more computing machines is trained to identify body parts in visual data using the plurality of synthetic images.

18. The method of claim 17, wherein the one or more human body parts comprise one or more of: a head, a torso, an upper arm, a lower arm, an upper leg, and a lower leg.

19. The method of claim 17, wherein:
training the joint prediction module to predict joint locations in visual data using the plurality of real images comprises computing a first Euclidian loss between predicted joint locations in the plurality of real images and ground truth joint locations in the plurality of real images; and
training the part affinity field prediction module to identify adjacent joints in visual data using the plurality of real images comprises computing a second Euclidian loss between predicted adjacent joints in the plurality of real images and ground truth adjacent joints in the plurality of real images; and wherein:
a loss function based on the first Euclidian loss and the second Euclidian loss is minimized.

20. The method of claim 17, wherein:
training the joint prediction module to predict joint locations in visual data using the plurality of synthetic images comprises computing a first cross entropy loss between predicted joint locations in the plurality of synthetic images and ground truth joint locations in the plurality of synthetic images;
training the part affinity field prediction module to identify adjacent joints in visual data using the plurality of synthetic images comprises computing a second cross entropy loss between predicted adjacent joints in the plurality of synthetic images and ground truth adjacent joints in the plurality of synthetic images; and
training the body part prediction module to identify body parts in visual data using the plurality of synthetic images comprises computing a third cross entropy loss between predicted body parts in the plurality of synthetic images and ground truth body parts in the plurality of synthetic images; and wherein:
a loss function based on the first cross entropy loss, the second cross entropy loss, and the third cross entropy loss is minimized.
